(19) United States
(12) Patent Application Publication
(10) Pub. No.: US 2011/0125496 A1
(43) Pub. Date: May 26, 2011

(54) SPEECH RECOGNITION DEVICE, SPEECH RECOGNITION METHOD, AND PROGRAM

(76) Inventors: Satoshi ASAKAWA, Tokyo (JP); ATSUO HIROE, KANAGAWA (JP); HIROAKI OGAWA, CHIBA (JP); HITOSHI HONDA, KANAGAWA (JP); TSUTOMU SAWADA, TOKYO (JP)

(21) Appl. No.: 12/943,450

(22) Filed: Nov. 10, 2010

(30) Foreign Application Priority Data
Nov. 20, 2009 (JP) P2009-265076

(51) Int. Cl. G10L 15/00

(52) U.S. Cl. 704/231; 704/E15.001

(57) ABSTRACT

A speech recognition device includes a sound source separation unit configured to separate a mixed signal of outputs of a plurality of sound sources into signals corresponding to individual sound sources and generate separation signals of a plurality of channels; a speech recognition unit configured to input the separation signals of the plurality of channels, the separation signals being generated by the sound source separation unit, perform a speech recognition process, generate a speech recognition result corresponding to each channel, and generate additional information serving as evaluation information on the speech recognition result corresponding to each channel; and a channel selection unit configured to input the speech recognition result and the additional information, calculate a score of the speech recognition result corresponding to each channel by applying the additional information, and select and output a speech recognition result having a high score.

### BACKGROUND OF THE INVENTION

1. Field of the Invention

The present invention relates to a speech recognition device, a speech recognition method, and a program. More particularly, the present invention relates to a speech recognition device that separates a mixed signal of a plurality of speech signals by using independent component analysis (ICA) and performs speech recognition, to a speech recognition method for use therewith, and to a program for use therewith.

2. Description of the Related Art

An example of processing for separating a mixed signal of a plurality of speech signals is independent component analysis (ICA). By applying speech recognition to a separation result obtained by ICA, sound is separated into desired sound, and sound other than that. Thereafter, by performing a speech recognition process, it is possible to perform speech recognition of a desired sound source with high accuracy.

Several systems in which a sound source separation process and a speech recognition process based on such an independent component analysis (ICA) are combined already exist. The system of the related art is of a configuration in which a desired channel (sound source) is selected from a plurality of output channels corresponding to the plurality of respective sound sources obtained as a result of ICA, and is used for input for speech recognition.

First, as the background art of the present invention, an overview of independent component analysis (ICA) will be given. ICA is one kind of multivariate analysis, and is a technique for separating a multidimensional signal by using the statistical nature of signals. For the details of ICA itself, reference should be made to, for example, “Introduction to Independent Component Analysis”, written by Noboru MURATA, Tokyo Denki University Press.

In the following, ICA of a sound signal, in particular, ICA of a time-frequency domain, will be described. A situation is considered in which, as shown in FIG. 1, different sounds are being emitted from N sound sources and these sounds are observed using N microphones. Until sound (original signal) output by a sound source arrives, there is a time delay, reflection, and the like. Therefore, a signal (observed signal) observed by a microphone k can be represented by an expression in which convolution computation (convolution) of an original signal and a transfer function are totaled for all the sound sources, as in expression [1.1]. In the following, this mixture will be referred to as a convolutive mixture. An observed signal of a microphone n is denoted as xₙ(t). The observed signals of the microphone 1 and the microphone 2 are denoted as x₁(t) and x₂(t), respectively. If the observed signals for all the microphones are represented by one expression, they are represented as expression [1.2] described below.

$${x}_{k} ( t ) = {\sum }_{j = 1}^{N} {\sum }_{l = 0}^{L} {a}_{kj} ( l ) {s}_{j} ( t - l ) = {\sum }_{j = 1}^{N} \{ {a}_{kj} * {s}_{j} \} \qquad [ 1.1 ]$$

x(t)=A^{└0┘}s(t)+ . . . +A^{└L┘}s(t−L) [1.2]

where

$$s ( t ) = [ \begin{matrix}{s}_{1} ( t ) \\ ⋮ \\ {s}_{N} ( t )\end{matrix} ] , x ( t ) = [ \begin{matrix}{x}_{1} ( t ) \\ ⋮ \\ {x}_{n} ( t )\end{matrix} ] , {A}^{[ l ]} = [ \begin{matrix}{a}_{11} ( l ) & … & {a}_{1 N} ( l ) \\ ⋮ & ⋱ & ⋮ \\ {a}_{n 1} ( l ) & … & {a}_{nN} ( l )\end{matrix} ] \qquad [ 1.3 ]$$

In the above expressions, x(t) and s(t) are column vectors in which xₖ(t) and sₖ(t) are elements, respectively, and A^{[l]} is a matrix of n×N in which a^{[l]}ₖⱼ is an element. In the following, n=N.

It is common knowledge that the convolutive mixture of a time domain is represented by an instantaneous mixture in the time-frequency domain, and ICA of a time-frequency domain utilizes the features thereof.

For the time-frequency domain ICA itself, reference should be made to “19.2.4. Fourier Transform Method” of “Detailed Explanation of Independent Component Analysis” and “Speech Signal Separation Device/Noise Removal Device and Method” (Japanese Unexamined Patent Application Publication No. 2006-238409), etc.

When both sides of expression [1.2] above are subjected to a short-time Fourier transform, expression [2.1] described below is obtained.

X(ω,t)=A(ω)S(ω,t) [2.1]

$$\begin{matrix}X ( ω , t ) = [ \begin{matrix}{X}_{1} ( ω , t ) \\ ⋮ \\ {X}_{n} ( ω , t )\end{matrix} ] & [ 2.2 ] \\ A ( ω ) = [ \begin{matrix}{A}_{11} ( ω ) & … & {A}_{1 N} ( ω ) \\ ⋮ & ⋱ & ⋮ \\ {A}_{n 1} ( ω ) & … & {A}_{nN} ( ω )\end{matrix} ] & [ 2.3 ] \\ S ( ω , t ) = [ \begin{matrix}{S}_{1} ( ω , t ) \\ ⋮ \\ {S}_{N} ( ω , t )\end{matrix} ] & [ 2.4 ]\end{matrix}$$

Y(ω,t)=W(ω)X(ω,t) [2.5]

$$\begin{matrix}Y ( ω , t ) = [ \begin{matrix}{Y}_{1} ( ω , t ) \\ ⋮ \\ {Y}_{n} ( ω , t )\end{matrix} ] & [ 2.6 ] \\ W ( ω ) = [ \begin{matrix}{W}_{11} ( ω ) & … & {W}_{1 n} ( ω ) \\ ⋮ & ⋱ & ⋮ \\ {W}_{n 1} ( ω ) & … & {W}_{nn} ( ω )\end{matrix} ] & [ 2.7 ]\end{matrix}$$

In expression [2.1] above, ω denotes the frequency bin's number, and t denotes the frame's number.

If ω is fixed, this expression can be regarded as an instantaneous mixture (mixture without a time delay). Accordingly, in order to separate an observed signal, after calculation expression [2.5] for the separation result [Y] is prepared, a separation matrix W(ω) is determined so that each component of the separation result Y(ω, t) becomes most independent. On the basis of such a process, a separation signal is obtained from the mixed speech signal.

By inputting the separation signal obtained by this independent component analysis (ICA) to the speech recognition system, it is possible to obtain a recognition result corresponding to each sound source with high accuracy. A typical example of a system in which a sound source separation process and a speech recognition unit based on ICA are combined is shown in FIG. 2.

Sounds are collected by a plurality of microphones 101-1 to 101-N, and an input waveform corresponding to the sound signal obtained by each of the microphones 101-1 to 101-N is sent to a sound source separation unit 102. The sound source separation unit 102 performs a process for separating mixed sounds of a plurality of sound sources into individual sound sources that correspond to each sound source on the basis of the above-mentioned independent component analysis (ICA). In a channel selection unit 103, in a case where channel selection is to be performed on the basis of the sound source direction, in the sound source separation unit 102, sound source direction estimation is performed simultaneously.

A separated waveform indicating an individual speech signal corresponding to the sound source, and sound source direction information are output from the sound source separation unit 102 and are input to the channel selection unit 103. The channel selection unit 103 selects a channel in which a desired sound is contained from within the separated waveform corresponding to each sound source, which is input from the sound source separation unit 102. For example, the selection is made in accordance with a specification by a user, or the like. One selected separated waveform is output to the speech recognition unit 104.

The speech recognition unit 104 performs speech recognition by using, as an input, the separated waveform indicating the speech signal corresponding to a certain sound source, which is input from the channel selection unit 103, and outputs a speech recognition result of a specific sound source (desired sound).

The system in which a sound source separation process and a speech recognition process, which are based on ICA, are combined is configured to obtain a recognition result of a desired sound source by performing such a process. However, such a system has problems regarding uncertainty of ICA output and channel selection for selecting a desired sound. Hereinafter, these problems will be described.

First, the uncertainty of ICA output and a channel selection technique for selecting a desired sound will be described.

Uncertainty of ICA Output

In ICA, it is uncertain as to which channel each sound of the separation result corresponding to the original sound source is output. Thus, it is necessary to select in some way the channel in which the desired sound is contained. For example, in Japanese Unexamined Patent Application Publication No. 2009-53088, the uncertainty of ICA output is described.

Channel Selection Technique for Selecting Desired Sound

In a case where an output of ICA is output to subsequent processing means and some sort of process is to be performed, it is necessary to make a determination as to which channel the sound of the separation result corresponding to the original sound source has been output. In a case where, for example, a speech recognition process is performed as subsequent processing means, it is necessary to make a determination as to which channel the speech to be recognized has been output. In ICA, for example, when there are N microphones, inputs of N channels are made, and separation results of N channels are output. However, a various number of sound sources are set. In a case where the number of sound sources is smaller than the number of input channels, the output channel (sound source channel) corresponding to the sound source and the output channel (reverberation channel) in which sound, such as reverberation, which does not correspond to any sound source, is observed, are obtained as monitoring information.

When processing in which ICA and speech recognition are combined is considered, output channels of ICA can be classified in the following manner.

(1) Sound source channel corresponding to actual sound source
(2) Reverberation channel that does not correspond to sound source

Furthermore, (1) the sound source channel can be classified as follows.

(1-1) Channel for speech
(1-1-1) Utterance channel (intra-task utterance) in which content that is assumed to be input by speech recognition system is contained
(1-1-2) Utterance channel (extra-task utterance) in which content that is not assumed to be input by speech recognition system is contained
(1-2) Channel other than for speech (including, for example, chat between persons, which is not input to the system, is contained).

For the system that performs speech recognition on the basis of the sound source separation result by ICA, it is important that, among the above-described classifications, the speech of (1-1-1) utterance channel (intra-task utterance) in which content that is assumed as input by the speech recognition system is contained is recognized.

Examples of a technique for selecting a channel corresponding to such a desired sound source include the following methods.

### (a) Selection is Made on the Basis of the Magnitude of Power (Sound Volume)

This is a method of determining whether the channel is a desired sound source channel or a reverberation channel on the basis of the value of the power of each channel output so as to select the channel with the maximum power.

### (b) Sound Source Direction is Estimated, and Sound Source Direction Closest to the Front of the Device is Selected

This is a method in which ICA is performed, the direction from which the sound arrives is also estimated simultaneously, and a channel in which the sound source closest to the front of the device is output is selected as that for the desired sound.

(c) Selection is Made on the Basis of Speech/Non-Speech Discrimination and Comparison with Past Data

This is a technique in which, for example, it is determined whether or not the sound of each channel is a speech signal by a person, and comparison of stored past frequency feature quantities is made with a channel that has been determined to be a channel for a speech signal of a person, thereby making a determination as to the speech of a specific person. This technique has been disclosed in, for example, Japanese Unexamined Patent Application Publication No. 2007-279517.

Summary of Problems in the System of the Related Art

For example, in a system in which a sound source separation process and a speech recognition process based on ICA shown in FIG. 1 are combined, the problems are that the above-mentioned uncertainty of ICA output exists, and it is necessary to determine how a desired speech is selected from a plurality of channels, which are generated by ICA.

Problems in the system of the related art are organized and listed as follows.

(A) Problem of Applying Speech Recognition after Channel Selection

(A1) In a case where only one channel is selected, when a plurality of sounds are being emitted, there is a possibility that a sound other than the desired sound is selected.

(A2) In a case where a plurality of channels are selected, a plurality of speech recognition results are obtained, and it is necessary to select the speech recognition results once more.

### (B) Problems of Technique of Channel Selection of the Related Art

Three problems of the above-mentioned techniques of the related art will be given.

### (a) Problem of Channel Selection Technique Based on Magnitude of Power

If a channel is selected based on only the magnitude of power, there is a possibility that a sound source other than for speech is selected by mistake. For example, it is possible to distinguish between a sound source channel and a reverberation channel, but it is not possible to distinguish between speech and non-speech.

### (b) Problem of Technique for Estimating Sound Source Direction and Selecting Sound Source Direction Closest to Front

The desired speech does not necessarily arrive from the front.

(c) Problem of Technique for Making Selection on the Basis of Combination of Speech/Non-Speech Discrimination and Comparison with Past Data

In the speech/non-speech discrimination, it is not possible to make a determination up to the degree that the content is utterance content of a task assumed by the speech recognition system. It is possible to distinguish between a speech signal and other signals, but it is not possible to distinguish between an intra-task utterance and an extra-task utterance. As described above, the channel selection technique of the related art has various problems.

### SUMMARY OF THE INVENTION

It is desirable to provide a speech recognition device that performs a separation process in units of each sound source signal by using independent component analysis (ICA) and that performs a speech recognition process for a desired sound, a speech recognition method for use therewith, and a program for use therewith.

According to an embodiment of the present invention, there is provided a speech recognition device including: a sound source separation unit configured to separate a mixed signal of outputs of a plurality of sound sources into signals corresponding to individual sound sources and generate separation signals of a plurality of channels; a speech recognition unit configured to input the separation signals of the plurality of channels, the separation signals being generated by the sound source separation unit, perform a speech recognition process, generate a speech recognition result corresponding to each channel, and generate additional information serving as evaluation information on the speech recognition result corresponding to each channel; and a channel selection unit configured to input the speech recognition result and the additional information, calculate a score of the speech recognition result corresponding to each channel by applying the additional information, and select and output a speech recognition result having a high score.

In an embodiment of the speech recognition device according to the present invention, the speech recognition unit may calculate a recognition confidence of the speech recognition result as the additional information, and the channel selection unit may calculate a score of the speech recognition result corresponding to each channel by applying the recognition confidence.

In an embodiment of the speech recognition device according to the present invention, the speech recognition unit may calculate, as the additional information, an intra-task utterance degree indicating whether or not the speech recognition result is a recognition result related to a task assumed in the speech recognition device, and the channel selection unit may calculate a score of the speech recognition result corresponding to each channel by applying the intra-task utterance degree.

In an embodiment of the speech recognition device according to the present invention, the channel selection unit may apply, as score calculation data, at least one of the recognition confidence of the speech recognition result and the intra-task utterance degree indicating whether or not the speech recognition result is a recognition result related to a task assumed in the speech recognition device, and may calculate a score by combining at least one of speech power and sound source direction information.

In an embodiment of the speech recognition device according to the present invention, the speech recognition unit may include a plurality of speech recognition units, the number of the speech recognition units being equal to the number of channels of the separation signals of the plurality of channels, the separation signals being generated by the sound source separation unit, and the plurality of speech recognition units may receive separation signals corresponding to the plurality of respective channels, the separation signals being generated by the sound source separation unit, and may perform speech recognition processes in parallel.

According to another embodiment of the present invention, there is provided a speech recognition method performed in a speech recognition device, including the steps of: separating, by using a sound source separation unit, a mixed signal of outputs of a plurality of sound sources into signals of corresponding sound sources, and generating separation signals of a plurality of channels; inputting, by using a speech recognition unit, the separation signals of the plurality of channels, the separation signals being generated by the sound source separation unit, performing a speech recognition process, generating speech recognition results of the plurality of corresponding channels, and generating additional information serving as evaluation information on the speech recognition results of the corresponding channels; and inputting, by using a channel selection unit, the speech recognition results and the additional information, calculating a score of the speech recognition result of a corresponding channel by applying the additional information, and selecting and outputting a speech recognition result having a high score.

According to another embodiment of the present invention, there is provided a program for causing a speech recognition device to perform a speech recognition process, the speech recognition process including the steps of: separating, by using a sound source separation unit, a mixed signal of outputs of a plurality of sound sources into signals of corresponding sound sources, and generating separation signals of a plurality of channels; inputting, by using a speech recognition unit, the separation signals of the plurality of channels, the separation signals being generated by the sound source separation unit, performing a speech recognition process, generating speech recognition results of the plurality of corresponding channels, and generating additional information serving as evaluation information on the speech recognition results of the corresponding channels; and inputting, by using a channel selection unit, the speech recognition results and the additional information, calculating a score of the speech recognition result of a corresponding channel by applying the additional information, and selecting and outputting a speech recognition result having a high score.

The program according to the embodiment of the present invention is a program that can be provided using a storage medium provided in a computer-readable format or by a communication medium to, for example, an information processing device and a computer system, which are capable of executing various program codes. By providing such a program in a computer-readable format, processing corresponding to the program is realized in an information processing device or a computer system.

Further objects, features, and advantageous effects of the present invention will become apparent from the following detailed description of embodiments of the present invention and drawings attached thereto. Note that the system in the present specification refers to a logical assembly of a plurality of devices and is not limited to an assembly in which devices having individual structures are contained in a single housing.

According to the configuration of an embodiment of the present invention, by performing processing in which independent component analysis (ICA) is applied to an observed signal formed of a mixed signal in which outputs from a plurality of sound sources are mixed, a separation signal is generated, and a speech recognition process for each separation signal is performed. Furthermore, additional information serving as evaluation information for a speech recognition result is generated. As the additional information, the recognition confidence of the speech recognition result and the intra-task utterance degree indicating whether or not the speech recognition result is a recognition result related to a task assumed in the speech recognition device are calculated. The score of the speech recognition result corresponding to each channel is calculated by applying these items of additional information, and a recognition result having a high score is selected and output. With these processes, sound source separation and speech recognition for a mixed signal from a plurality of sound sources are realized, and a necessary recognition result can be obtained more reliably.

### BRIEF DESCRIPTION OF THE DRAWINGS

FIG. 1 illustrates a situation in which different sounds are being emitted from N sound sources, and these sounds are observed using N microphones;

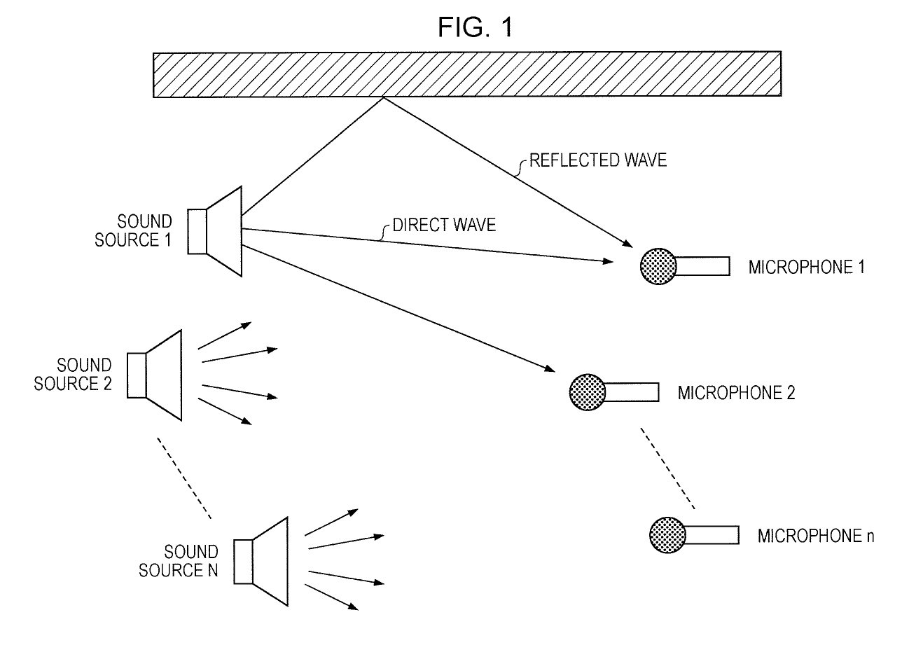

FIG. 2 illustrates an example of a system in which a sound source separation process and a speech recognition unit based on typical independent component analysis (ICA) are combined;

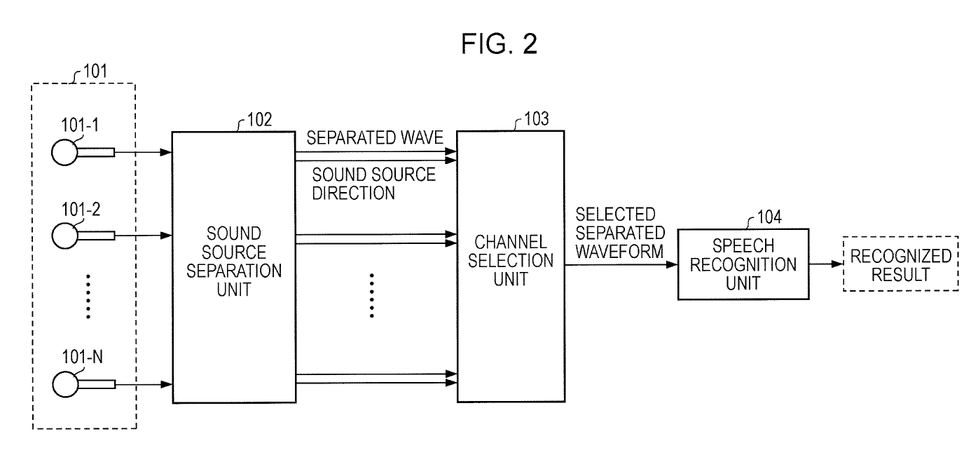

FIG. 3 illustrates the overall configuration of a speech recognition device and the overview of processing according to an embodiment of the present invention;

FIG. 4 illustrates the detailed configuration of a sound source separation unit 202 and a specific example of processing;

FIG. 5 illustrates the configuration of one speech recognition unit of speech recognition units 203-1 to 203-N provided in correspondence with channels;

FIG. 6 illustrates a detailed configuration of a channel selection unit 204 and a specific example of processing;

FIG. 7 is a flowchart illustrating the overall flow of processing performed by a speech recognition device according to an embodiment of the present invention;

FIG. 8 is a flowchart illustrating the details of a speech recognition process in step S103 in the flow shown in FIG. 7; and

FIG. 9 is a flowchart illustrating the details of a channel selection process in step S104 in the flow shown in FIG. 7.

### DESCRIPTION OF THE PREFERRED EMBODIMENTS

The details of a speech recognition device, a speech recognition method, and a program according to embodiments of the present invention will be described below with reference to the drawings. The description will be given in accordance with the following items.

1. Example of overall configuration of speech recognition device and overview of processing according to embodiment of the present invention
2. Detailed configuration of sound source separation unit, and specific example of processing
3. Detailed configuration of speech recognition unit, and specific example of processing
4. Detailed configuration of channel selection unit, and specific example of processing
5. Sequence of processing performed by speech recognition device

### 1. Example of Overall Configuration of Speech Recognition Device and Overview of Processing

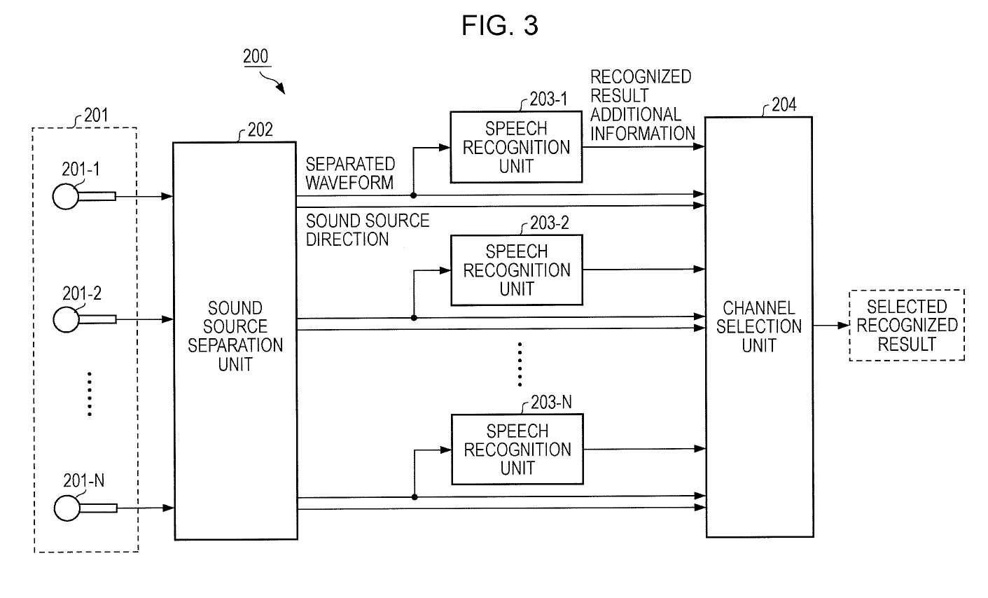

First, a description will be given, with reference to FIG. 3, of the overall configuration of a speech recognition device, and the overview of processing according to an embodiment of the present invention. The speech recognition device according to the embodiment of the present invention is a device that inputs a mixed signal of sounds that are output by a plurality of sound sources, that performs sound source separation, and that performs a speech recognition process using a sound source separation result. FIG. 3 illustrates an example of the configuration of a speech recognition device 200 according to an embodiment of the present invention.

Sounds are collected using a plurality of microphones 201-1 to 201-N, and input waveforms corresponding to sound signals obtained by the microphones 201-1 to 201-N are sent to the sound source separation unit 202. The sound source separation unit 202 performs a process for separating mixed sounds of a plurality of sound sources into individual sound sources that correspond to respective sound sources by applying, for example, independent component analysis (ICA). With this separation process, for example, a separated waveform of speech corresponding to each sound source is generated and output. In conjunction with this sound source separation process, the sound source separation unit 202 performs a process for estimating the sound source direction in which sound corresponding to each separated waveform arrives.

By performing a separation process based on independent component analysis (ICA) performed by the sound source separation unit 202, N separated waveforms corresponding to the number (N) of inputs are generated. Here, the number (N) of separated waveforms is set as the number of channels. The sound source separation unit 202 generates separated waveforms of N channels of channel 1 to channel N. However, the number of sound sources is not necessarily equal to N. There is a case in which some of the N channels output a speech separated waveform corresponding to a specific sound source, and the other channels output only noise.

The plurality of separated waveforms corresponding to respective sound sources, which are generated by the sound source separation unit 202, are individually output to the channel selection unit 204, and are further input to the speech recognition units 203-1 to 203-N that are set for corresponding separated waveforms. Furthermore, a plurality of items of sound source direction information corresponding to each sound source, which are generated by the sound source separation unit 202, are individually output to the channel selection unit 204.

Each of the speech recognition units 203-1 to 203-N performs a speech recognition process on a corresponding separated waveform output from the sound source separation unit 202. Each of the speech recognition units 203-1 to 203-N outputs, together with the speech recognition result, the confidence of the recognition result and the degree as to whether or not the utterance is an intra-task utterance (intra-task utterance degree), which are attached as additional information, to the channel selection unit 204.

The “intra-task utterance degree” is a degree as to whether the utterance is an utterance of a task assumed by the speech recognition device 200. More specifically, for example, in a case where the apparatus including the speech recognition device 200 is a television, when an operation request for a television, for example, a request for changing a volume (sound volume) or a request for changing a channel is contained in the speech recognition result, the possibility that the utterance is an intra-task utterance is high, and information in which the intra-task utterance degree is set to be high is output. For this determination process, a statistical language model held in the memory of the speech recognition device 200 is used. The statistical language model is data in which index values as to whether or not various words are words related to a task are set in advance.

The channel selection unit 204 inputs a separated waveform corresponding to each sound source from the sound source separation unit 202, and further inputs the following information from each of the speech recognition units 203-1 to 203-N:

a speech recognition result corresponding to each separated waveform, and

additional information (the confidence of the recognition result and the intra-task utterance degree).

By applying these items of input information, the channel selection unit 204 selects and outputs a speech recognition result of the channel in which a desired sound is contained.

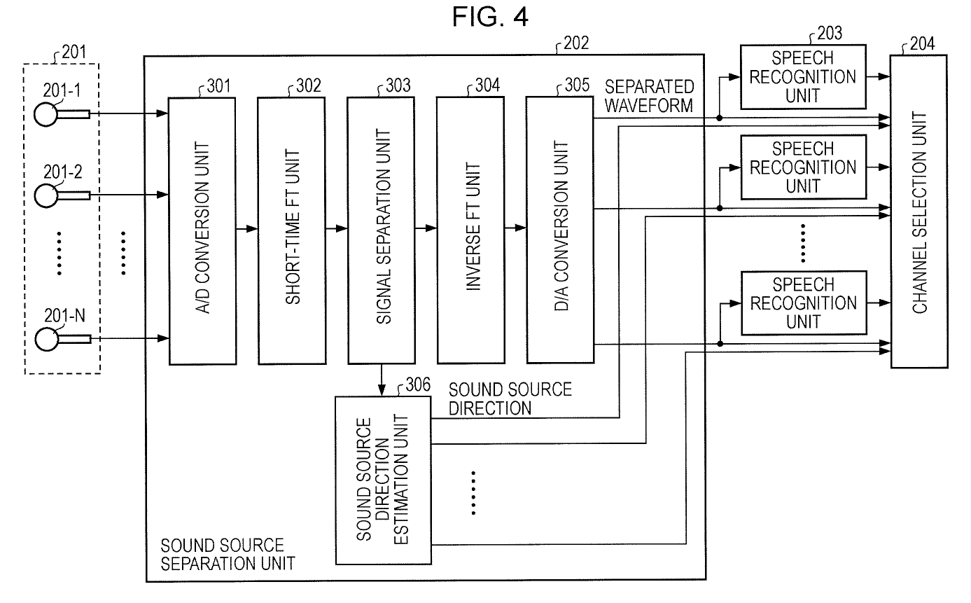

The processing of each component unit shown in FIG. 3 is performed under the control of the control unit (not shown in FIG. 3). The control unit is constituted by a CPU and the like, executes a program stored in a storage unit (not shown), and controls the processing of each component unit shown in FIG. 3. The detailed configuration of each component unit shown in FIG. 3 and a specific example of processing to be performed will be described with reference to FIG. 4 and subsequent figures.

### 2. Detailed Configuration of Sound Source Separation Unit and Specific Example of Processing

First, a description will be given, with reference to FIG. 4, of the detailed configuration of the sound source separation unit 202 and a specific example of processing. As shown in FIG. 4, the sound source separation unit 202 includes an A/D conversion unit 301, a short-time Fourier transform (FT) unit 302, a signal separation unit 303, an inverse Fourier transform (FT) unit 304, a D/A conversion unit 305, and a sound source direction estimation unit 306.

The individual input waveforms from the microphones 201-1 to 201-N are converted into digital observed signals in the A/D conversion unit 301 and are input to the short-time Fourier transform (FT) unit 302.

The short-time Fourier transform (FT) unit 302 performs a short-time Fourier transform (FT) process on an input signal that has been converted into a digital signal so as to be converted into a spectrogram, and inputs it to the signal separation unit 303. The spectrogram of each observed signal obtained by the short-time Fourier transform (FT) process is a signal of expression [2.1] described earlier, that is, X(ω, t).

The signal separation unit 303 receives the spectrogram of each observed signal generated by the short-time Fourier transform (FT) unit 302, and performs independent component analysis (ICA) described above so as to generate a separation result Y. This separation result becomes N separation results corresponding to N channels. This separation result is input to the inverse Fourier transform (FT) unit 304.

The inverse Fourier transform (FT) unit 304 performs an inverse Fourier transform process on the spectrograms corresponding to individual sound source signals so as to convert the spectrograms into signals in the time domain, and generates a sound source separation signal that is estimated to correspond to each sound source. The separation signals are generated as signals for the number of channels, that is, N signals.

These N separation signals are input to the D/A conversion unit 305, whereby the signals are converted into N separated waveforms as analog signals by D/A conversion. These N separated waveforms are output to the speech recognition units 203-1 to 203-N corresponding to the channels 1 to N, respectively, and the channel selection unit 204.

The sound source direction estimation unit 306 estimates the direction in which each independent signal arrives by using some of the estimation results in the signal separation unit 303. This estimation information is also N items of sound source direction information corresponding to respective N channels. The N items of sound source direction information generated by the sound source direction estimation unit 306 are output to the channel selection unit 204.

### 3. Detailed Configuration of Speech Recognition Unit, and Specific Example of Processing

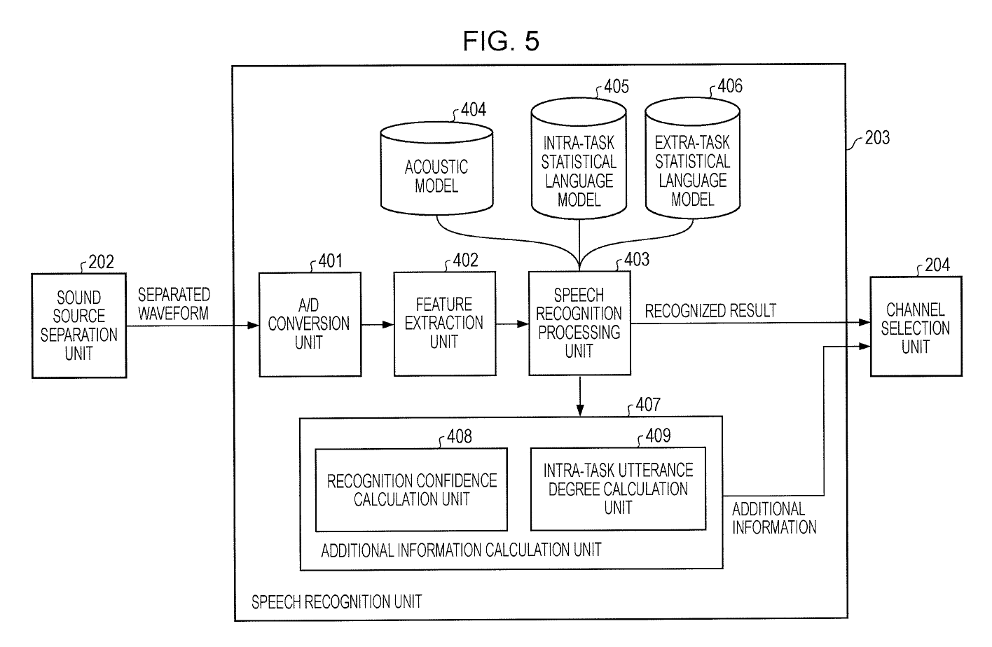

Next, a description will be given, with reference to FIG. 5, of the detailed configuration of the speech recognition units 203-1 to 203-N and a specific example of processing. FIG. 5 illustrates one speech recognition unit among the speech recognition units 203-1 to 203-N provided in such a manner as to correspond to each channel. Each of the N speech recognition units 203-1 to N has a configuration shown in FIG. 5.

As shown in FIG. 5, the speech recognition unit 203 includes an A/D conversion unit 401, a feature extraction unit 402, a speech recognition processing unit 403, and an additional information calculation unit 407. The additional information calculation unit 407 includes a recognition confidence calculation unit 408 and an intra-task utterance degree calculation unit 409. Furthermore, the speech recognition unit 203 is stored with an acoustic model 404, an intra-task statistical language model 405, and an extra-task statistical language model 406, so that processing using the data of three models is performed.

The input of the speech recognition unit 203 shown in FIG. 5 is one separated waveform corresponding to one channel k (k=1 to N) among the N channels that are separated by the sound source separation unit 202. Each of the speech recognition units 203-1 to 203-N inputs the separated waveform of the channel k (k=1 to N), and the units perform speech recognition processes in parallel on the basis of the separated waveform of each channel.

As described above, in the speech recognition units 203-1 to 203-N, processing on N separated waveforms of N channels is performed in parallel. A description will be given, with reference to FIG. 5, of a process for a separated waveform corresponding to one channel.

First, the separated waveform corresponding to one channel is input to the A/D conversion unit 401. The A/D conversion unit 401 converts the separated waveform that is an analog signal into a digital observed signal. The digital observed signal is input to the feature extraction unit 402.

The feature extraction unit 402 receives a digital observed signal from the A/D conversion unit 401, and extracts the feature that is used for speech recognition from the digital observed signal. The feature extraction process can be performed in accordance with an existing speech recognition algorithm. The extracted feature is input to the speech recognition processing unit 403.

The speech recognition processing unit 403 performs a speech recognition process using the feature input from the feature extraction unit 402. The speech recognition processing unit 403 performs a plurality of recognition processes in which, in addition to the acoustic model 404, different language models, that is, a speech recognition process using the intra-task statistical language model 405, and a speech recognition process using the extra-task statistical language model 406, are applied.

For example, words registered in the intra-task statistical language model 405 are compared with words obtained as a result of the speech recognition process in order to select a matched word and obtain a recognition result. A score corresponding to the matching degree is calculated. Furthermore, words registered in the extra-task statistical language model 406 are compared with words obtained as a result of performing the speech recognition process so as to select a matched word and obtain a recognition result. Furthermore, a score corresponding to the matching degree is calculated. A result having the highest recognition score is selected from among the plurality of recognition results using these different models, and is output as a speech recognition result. For the intra-task statistical language model 405 and the extra-task statistical language model 406, a plurality of different models can be used.

The speech recognition result generated by the speech recognition processing unit 403 is output to the channel selection unit 204, and is also output to the additional information calculation unit 407 in the speech recognition unit 203. The information output to the additional information calculation unit 407 also contains the above-mentioned score information.

The additional information calculation unit 407 includes a recognition confidence calculation unit 408 and an intra-task utterance degree calculation unit 409. The recognition confidence calculation unit 408 calculates the recognition confidence of the speech recognition result generated by the speech recognition processing unit 403. The recognition confidence of the speech recognition result is evaluated by using evaluation reference data such that, for example, the validity of the sequence of the recognized words is stored in advance in memory. More specifically, it is possible to calculate the recognition confidence by applying the configuration disclosed in Japanese Unexamined Patent Application Publication No. 2005-275348.

The intra-task utterance degree calculation unit 409 calculates the intra-task utterance degree of the speech recognition result generated by the speech recognition processing unit 403. The intra-task utterance degree is, as described above, the degree as to whether or not the utterance is an utterance of a task assumed by the speech recognition device 200. More specifically, for example, in a case where the apparatus including the speech recognition device 200 is a television, when the word contained in the speech recognition result generated by the speech recognition processing unit 403 is a word for a request for operating a television, for example, a request for changing a volume (sound volume) or a request for changing a channel, the possibility that the utterance is an intra-task utterance is high, and the intra-task utterance degree is increased. When many words that are not related to such a task are contained in the speech recognition result, the intra-task utterance degree is set to be low.

As a specific process, the process using the score obtained by the above-mentioned speech recognition processing unit 403 makes it possible to calculate the intra-task utterance degree. That is, a first score matching the matching degree between the word obtained as a result of the speech recognition process and the registered word of the intra-task statistical language model 405 is compared with a second score matching the matching degree between the word obtained as a result of the speech recognition process and the registered word of the extra-task statistical language model 406. When the first score is higher than the second score, the intra-task utterance degree is set to be high, and when the second score is higher than the first score, the intra-task utterance degree is set to be low.

The additional information calculation unit 407 outputs, as additional information corresponding to the speech recognition result, the recognition confidence calculated by the recognition confidence calculation unit 408 and the intra-task utterance degree calculated by the intra-task utterance degree calculation unit 409, to the channel selection unit 204.

### 4. Detailed Configuration of Channel Selection Unit, and Specific Example of Processing

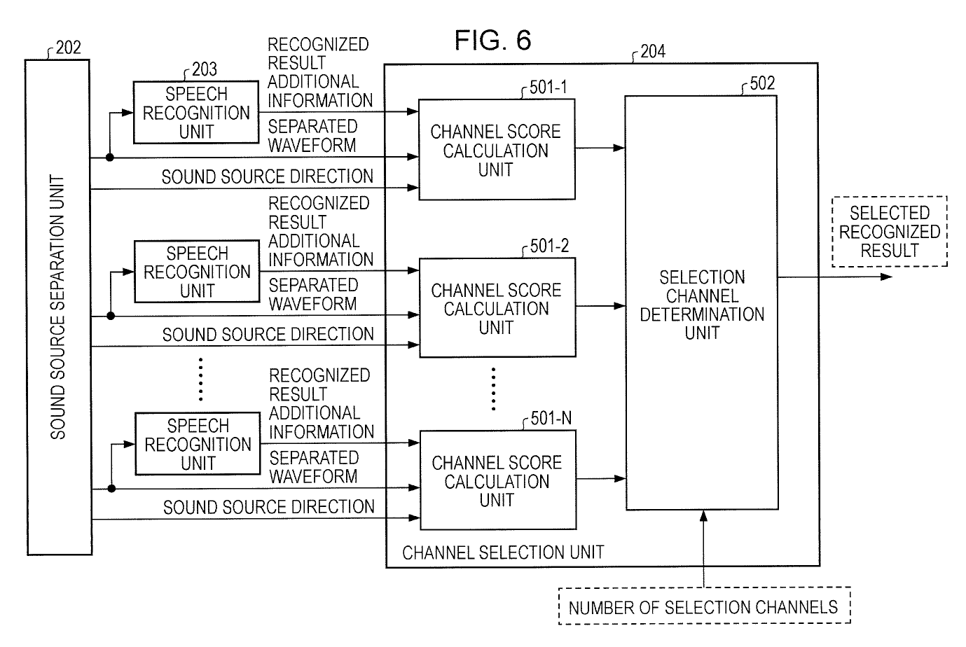

Next, a description will be given, with reference to FIG. 6, of the detailed configuration of the channel selection unit 204 and a specific example of processing. As shown in FIG. 6, the channel selection unit 204 includes channel score calculation units 501-1 to 501-N, and a selection channel determination unit 502.

The channel score calculation units 501-1 to 501-N are provided in such a manner as to correspond to the channels 1 to N. Each of the channel score calculation units 501-1 to 501-N receives, as channel correspondence information, the following information: a speech recognition result and additional information (the recognition confidence and the intra-task utterance degree) from the speech recognition unit 203, and a separated waveform and sound source direction information from the sound source separation unit 202.

By using these items of channel correspondence information, the channel score calculation units 501-1 to N calculate the score of the speech recognition result of each channel. For example, it is set as follows:

the recognition confidence=p,

the intra-task utterance degree=q, and

the power of separated waveform=r.

Regarding the recognition confidence=p, the higher the confidence, the greater the value of p. Regarding the intra-task utterance degree=q, the higher the possibility of the intra-task utterance=r, the greater the value of q. Regarding the power of the separated waveform, the larger the power (sound volume), the greater the value of r is set.

In this case, the score Sk of the channel k is calculated as Sk=ap+bq+cr, where a, b, and c are preset coefficients (weight coefficients).

Furthermore, the sound source direction is considered. As an evaluation value in which the closer the sound source direction is to the front of the device, the higher the evaluation value becomes, the sound source direction evaluation value=h may be used, so that the score Sk may be calculated as Sk=ap+bq+cr+dh, where a, b, c, and d are preset coefficients (weight coefficients).

These scores Sk (k=1 to N) corresponding to the channels are calculated in the channel score calculation units 501-1 to 501-N, and are input to the selection channel determination unit 502.

The selection channel determination unit 502 receives the scores S1 to SN corresponding to the N channels, which are input from the channel score calculation units 501-1 to 501-N, respectively, performs a process for comparing these scores, selects a speech recognition result of the channel having a high score, and outputs the speech recognition result as a recognition result.

The selection channel determination unit 502 outputs M preset recognition results from among the recognition results of channels having a high score. The number M of outputs can be set externally by a user.

The selection channel determination unit 502 outputs recognition results for the higher order M channels of the scores as selected recognition results. The value of the number M of selection channels are set in accordance with the use form. For example, when the number of users is one, an input of only one utterance at one time is assumed, thus, M=1. When there is a possibility that a plurality of persons input utterances at the same time, a value greater than 1 is set.

### 5. Sequence of Processing Performed by Speech Recognition Device

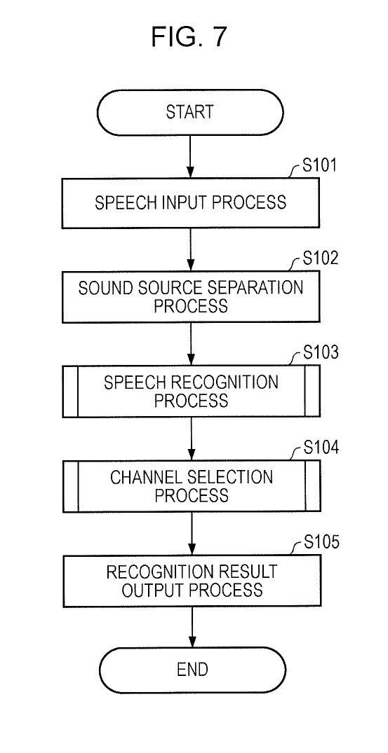

Next, a description will be given, with reference to the flowcharts of FIG. 7 and subsequent figures, of a sequence of processing performed by the speech recognition device according to an embodiment of the present invention.

The flowchart shown in FIG. 7 illustrates the overall flow of processing performed by the speech recognition device according to the embodiment of the present invention.

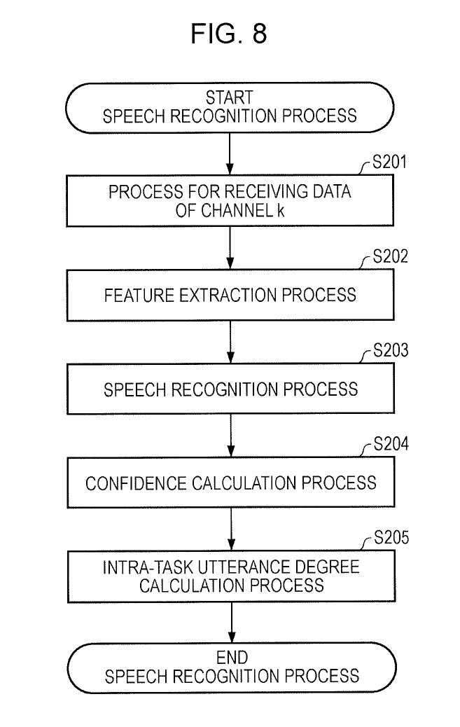

FIG. 8 is a flowchart illustrating the details of the speech recognition process of step S103 in the flow shown in FIG. 7.

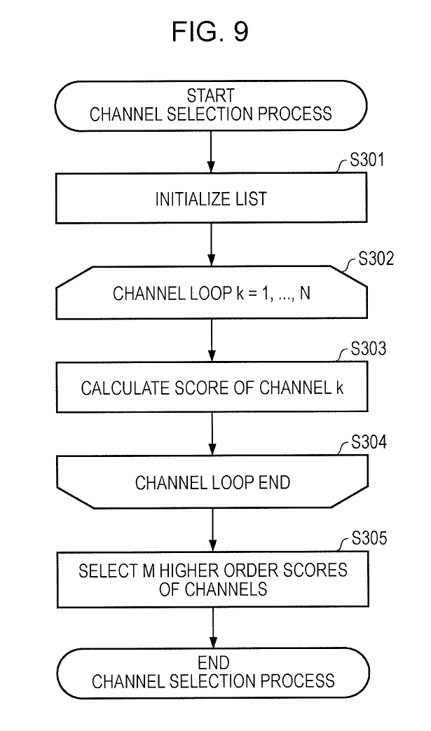

FIG. 9 is a flowchart illustrating the details of the channel selection process of step S104 in the flow shown in FIG. 7.

Processings in accordance with the flowcharts shown in FIGS. 7 to 9 are performed under the control of the control unit constituted by a CPU and the like, as described above. The control unit executes a program stored in a storage unit, thereby outputting a command and the like as appropriate to each component unit described with reference to FIGS. 3 to 5 so as to perform processing control. Thus, processings in accordance with the flowcharts shown in FIGS. 7 to 9 are performed.

First, a description will be given below, with reference to the flowchart shown in FIG. 7, of the overall flow of the processing performed by the speech recognition device according to the embodiment of the present invention. The process of each process step will be described in correspondence with the block diagram of FIG. 3.

In step S101, a sound input process from microphones 201-1 to 201-N is performed. Sounds are collected and input using N microphones arranged at various positions. If there are N microphones, input waveforms of N channels are obtained.

In step S102, a sound source separation process is performed. This is a process of the sound source separation unit 202 shown in FIG. 3, and corresponds to a process described with reference to FIG. 3. As described earlier with reference to FIG. 3, the sound source separation unit 202 performs a sound source separation process using ICA on input waveforms for the number of N channels, and generates separated waveforms for the number of N channels. For performing this process, the information on the sound source direction corresponding to the separated waveform of each channel may be obtained.

The process of the subsequent step S103 is a speech recognition process. This speech recognition process is a process performed in the speech recognition units 203-1 to 203-N shown in FIG. 3, and corresponds to the process described with reference to FIG. 4. In the speech recognition process of step S103, a speech recognition result corresponding to each channel, recognition confidence serving as additional information, and an intra-task utterance degree are generated. The details of the speech recognition process of step S103 will be described later with reference to the flowchart of FIG. 8.

The process of the subsequent step S104 is a channel selection process. This channel selection process is a process performed in the channel selection unit 204 shown in FIG. 3, and corresponds to the process described with reference to FIG. 6. In the channel selection process of step S104, a channel correspondence score is calculated on the basis of the result of the speech recognition process, the additional information, and the like, and the recognition results are selected by prioritizing results having a high score. The details of the channel selection process of step S104 will be described later with reference to the flowchart of FIG. 9.

The process of the subsequent step S105 is a recognition result output process. This recognition result output process is also a process performed in the channel selection unit 204 shown in FIG. 3, and corresponds to the process described with reference to FIG. 6. In the recognition result output process of step S105, M speech recognition results are output in ascending order of channel correspondence score, which has been calculated in step S104, in correspondence with the preset number (M) of outputs.

Next, a description will be given, with reference to the flowchart shown in FIG. 8, of the detailed sequence of the speech recognition process of step S103 in the flowchart of FIG. 7. This speech recognition process is a process performed in the speech recognition units 203-1 to 203-N shown in FIG. 3, and corresponds to the process described with reference to FIG. 5.

Here, the process in the channel k (process of the speech recognition unit 203-k) among the channels 1 to N will be described. Since there is no dependence relationship among the channels in the speech recognition process, the respective speech recognitions can be processed in sequence and can also be performed in parallel.

In step S201, data of the output channel k, which is the separation processing result of the sound source separation unit 202, is received. In step S202, a feature extraction process is performed. This feature extraction process is a process of the feature extraction unit 402 shown in FIG. 5. The feature extraction unit 402 extracts the feature used for speech recognition from the observed signal.

Next, in the subsequent step S203, a speech recognition process is performed. This speech recognition process is a process of the speech recognition processing unit 403 shown in FIG. 5. As described above, the speech recognition processing unit 403 performs a plurality of recognition processes in which, in addition to the acoustic model 404, different language models, that is, a speech recognition process using the intra-task statistical language model 405, and a speech recognition process using the extra-task statistical language model 406, are applied.

Next, in step S204, a confidence calculation process is performed. This confidence calculation process is a process performed by the recognition confidence calculation unit 408 of the additional information calculation unit 407 shown in FIG. 5.

The recognition confidence calculation unit 408 calculates the recognition confidence of the speech recognition result generated by the speech recognition processing unit 403. For example, the recognition confidence calculation unit 408 calculates the recognition confidence by using the evaluation reference data in which the validity of the sequence of the recognized words is stored in advance in the memory.

Next, in step S205, an intra-task utterance degree calculation process is performed. The intra-task utterance degree calculation process is a process performed by the intra-task utterance degree calculation unit 409 of the additional information calculation unit 407 shown in FIG. 5.

The intra-task utterance degree calculation unit 409 calculates the intra-task utterance degree of the speech recognition result generated by the speech recognition processing unit 403. In a case where the words contained in the speech recognition result generated by the speech recognition processing unit 403 contain many words related to the task, the possibility that the utterance an intra-task utterance is high, and the intra-task utterance degree is increased. In a case where the words contained in the speech recognition result contain many words that are not related to such a task, the intra-task utterance degree is set to be low.

In accordance with the flowchart shown in FIG. 8, the speech recognition unit 203 generates, as the channel correspondence data, the speech recognition result, and the additional information (the recognition confidence and the intra-task utterance degree), and supplies the data to the channel selection unit 204.

Next, a description will be given, with reference to the flowchart shown in FIG. 9, of the detailed sequence of the channel selection process of step S104 in the flowchart of FIG. 7. The channel selection process is a process performed in the channel selection unit 204 shown in FIG. 3, and corresponds to the process described with reference to FIG. 6.

In step S301, a process for initializing an output list is performed. The output list is a list in which the recognition results of the channels 1 to N are arranged in ascending order of score. In accordance with this output list, the selection channel determination unit 502 shown in FIG. 6 selects and outputs the recognition results for a predetermined number M of outputs on the basis of the recognition results of high scores. In step S301, an output list initialization process is performed, that is, a list is reset.

The processes of the subsequent steps S302 to S304 are a loop process that is repeatedly performed in correspondence with the data of the channels k=1 to N. In step S303, a score corresponding to the channel k is calculated. For example, as described earlier, the calculation of a score is performed by setting the recognition confidence=p, the intra-task utterance degree=q, and the power of a separated waveform=r, and by setting the score Sk of the channel k as Sk=ap+bq+cr, where a, b, and c are preset coefficient (weight coefficients). Alternatively, the sound source direction is also considered, and by using the sound source direction evaluation value=h, the score Sk is calculated as Sk=ap+bq+cr+dh. By performing such a process, the score of the channel k is calculated.

In steps S302 to S304, N scores S1 to SN corresponding to speech recognition results that correspond to N channels 1 to N are calculated.

Finally, in step S305, recognition results, the number of which corresponds to the prespecified number (M) of outputs, are selected from the higher order scores of the channels, and output. This process is a process of the selection channel determination unit 502 shown in FIG. 6.

The selection channel determination unit 502 receives the scores S1 to SN corresponding to the respective N channels, which are input from the channel score calculation units 501-1 to 501-N, performs a process for comparing these scores so as to select a speech recognition result of a channel having a high score, and outputs the speech recognition result as a recognition result.

As described above, in the speech recognition device according to the embodiment of the present invention, by applying speech recognition to each output channel of sound source separation by ICA, a channel corresponding to the desired sound is selected on the basis of the result. Information about the confidence of the speech recognition result and information as to whether or not the utterance is an utterance in the task assumed by the speech recognition device are attached, and on the basis of the additional information, channel selection is performed. Thus, it is possible to solve the problem of the error of the ICA output channel selection.

Examples of the advantages offered by the processing performed by the speech recognition device according to the embodiment of the present invention include the following advantages.

(a) By using the confidence of the speech recognition, the problem that a channel other than that of a desired speech is selected by mistake is solved.

(b) In setting in which information on the sound source direction is not used, channel selection that does not depend on the direction in which a desired speech arrives becomes possible.

(c) By using information as to whether or not the content is intra-task utterance content, it is possible to reject interference sound that is not assumed as input by the speech recognition system.

As has been described above, the present invention has been described in detail while referring to the specific embodiments. However, it is self-explanatory that those skilled in the art can make modifications to and substitutions for the embodiments without departing from the spirit and scope of the present invention. The present invention has been disclosed in the form of exemplary embodiments and the invention should not be construed as being limited to the embodiments set forth herein. In order to determine the gist of the present invention, the claims should be taken into consideration.

Note that the series of processes described in the specification can be executed by hardware, software, or a combination of both. In the case where the series of processes is to be performed by software, a program recording the processing sequence may be installed into a memory in a computer incorporated in dedicated hardware and executed. Alternatively, the program may be installed on a general-purpose computer capable of performing various processes and executed. For example, the program may be prerecorded on a recording medium. Note that, besides installing the program from the recording medium to a computer, the program may be installed on a recording medium such as an internal hard disk via a network such as a local area network (LAN) or the Internet.

Note that the various processes described in the specification are not necessarily performed sequentially in the orders described, and may be performed in parallel or individually in accordance with the processing performance or necessity of an apparatus that performs the processes. In addition, the system in the present specification refers to a logical assembly of a plurality of devices and is not limited to an assembly in which devices having individual structures are contained in a single housing.

As has been described above, according to the configuration of an embodiment of the present invention, by performing a process in which independent component analysis (ICA) is applied to an observed signal formed of a mixed signal in which outputs from a plurality of sound sources are mixed, a separation signal is generated, and a speech recognition process for each separation signal is performed. Furthermore, additional information serving as evaluation information on a speech recognition result is generated. The recognition confidence of a speech recognition result serving as additional information, and an intra-task utterance degree indicating whether or not the speech recognition result is a recognition result related to a task assumed in the speech recognition device are calculated. By applying these items of additional information, the score of the speech recognition result corresponding to each channel is calculated, and a recognition result having a high score is selected and output. As a result of performing these processes, sound source separation and speech recognition for a mixed signal from a plurality of sound sources are realized, making it possible to more reliably obtain a necessary recognition result.

The present application contains subject matter related to that disclosed in Japanese Priority Patent Application JP 2009-265076 filed in the Japan Patent Office on Nov. 20, 2009, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A speech recognition device comprising:
a sound source separation unit configured to separate a mixed signal of outputs of a plurality of sound sources into signals corresponding to individual sound sources and generate separation signals of a plurality of channels;
a speech recognition unit configured to input the separation signals of the plurality of channels, the separation signals being generated by the sound source separation unit, perform a speech recognition process, generate a speech recognition result corresponding to each channel, and generate additional information serving as evaluation information on the speech recognition result corresponding to each channel; and
a channel selection unit configured to input the speech recognition result and the additional information, calculate a score of the speech recognition result corresponding to each channel by applying the additional information, and select and output a speech recognition result having a high score.

2. The speech recognition device according to claim 1,
wherein the speech recognition unit calculates a recognition confidence of the speech recognition result as the additional information, and
wherein the channel selection unit calculates a score of the speech recognition result corresponding to each channel by applying the recognition confidence.

3. The speech recognition device according to one of claims 1 and 2,
wherein the speech recognition unit calculates, as the additional information, an intra-task utterance degree indicating whether or not the speech recognition result is a recognition result related to a task assumed in the speech recognition device, and
wherein the channel selection unit calculates a score of the speech recognition result corresponding to each channel by applying the intra-task utterance degree.

4. The speech recognition device according to claim 1, wherein the channel selection unit applies, as score calculation data, at least one of the recognition confidence of the speech recognition result and the intra-task utterance degree indicating whether or not the speech recognition result is a recognition result related to a task assumed in the speech recognition device, and calculates a score by combining at least one of speech power and sound source direction information.

5. The speech recognition device according to any one of claims 1 to 4,
wherein the speech recognition unit includes a plurality of speech recognition units, the number of the speech recognition units being equal to the number of channels of the separation signals of the plurality of channels, the separation signals being generated by the sound source separation unit, and
wherein the plurality of speech recognition units receive separation signals corresponding to the plurality of respective channels, the separation signals being generated by the sound source separation unit, and perform speech recognition processes in parallel.

6. A speech recognition method performed in a speech recognition device, comprising the steps of:
separating, by using a sound source separation unit, a mixed signal of outputs of a plurality of sound sources into signals of corresponding sound sources, and generating separation signals of a plurality of channels;
inputting, by using a speech recognition unit, the separation signals of the plurality of channels, the separation signals being generated by the sound source separation unit, performing a speech recognition process, generating speech recognition results of the plurality of corresponding channels, and generating additional information serving as evaluation information on the speech recognition results of the corresponding channels; and
inputting, by using a channel selection unit, the speech recognition results and the additional information, calculating a score of the speech recognition result of a corresponding channel by applying the additional information, and selecting and outputting a speech recognition result having a high score.

7. A program for causing a speech recognition device to perform a speech recognition process, the speech recognition process comprising the steps of:
separating, by using a sound source separation unit, a mixed signal of outputs of a plurality of sound sources into signals of corresponding sound sources, and generating separation signals of a plurality of channels;
inputting, by using a speech recognition unit, the separation signals of the plurality of channels, the separation signals being generated by the sound source separation unit, performing a speech recognition process, generating speech recognition results of the plurality of corresponding channels, and generating additional information serving as evaluation information on the speech recognition results of the corresponding channels; and
inputting, by using a channel selection unit, the speech recognition results and the additional information, calculating a score of the speech recognition result of a corresponding channel by applying the additional information, and selecting and outputting a speech recognition result having a high score.
